(19) United States
(12) Patent Application Publication
(10) Pub. No.: US 2010/0271180 A1
(43) Pub. Date: Oct. 28, 2010

(54) RADIO FREQUENCY IDENTIFICATION (RFID) CREDENTIAL FOR GUEST SERVICES

(75) Inventors: Robert R. Oberle, Macungie, PA (US); Britt Peace, Roswell, GA (US)

Correspondence Address: FLIESLER MEYER LLP, 650 CALIFORNIA STREET, 14TH FLOOR, SAN FRANCISCO, CA, 94108, US

(73) Assignee: RCD TECHNOLOGY INC., QUAKERTOWN, PA (US)

(21) Appl. No.: 12/729,071

(22) Filed: Mar. 22, 2010

Related U.S. Application Data
(60) Provisional application No. 61/164,701, filed on Mar. 30, 2009.

(51) Int. Cl. H04Q 5/22

(52) U.S. Cl. 340/10.1

(57) ABSTRACT

A Radio Frequency Identification Device (RFID) tag can be used to store a Hospitality Industry Organization ID of a customer. The RFID tag can be detected and then the Hospitality Industry Organization ID can be determined by using a device at a hospitality location to determine information about the customer to facilitate service for the consumer.

### CLAIM OF PRIORITY

This application claims priority to U.S. Provisional Application No. 61/164,701 entitled “RFID CREDENTIAL FOR GUEST SERVICES” by Robert R. Oberle, et al., filed Mar. 30, 2009, which is hereby incorporated by reference [Atty. Docket No. RCDT-01024US0].

### BACKGROUND

The present invention concerns a Radio Frequency Identification device (RFID) system.

### BRIEF DESCRIPTION OF THE DRAWINGS

FIG. 1 shows the operation of one embodiment of the present invention.

FIG. 2 is a flow chart that illustrates another embodiment of the present invention.

FIG. 3 illustrates a Radio Frequency Identification (RFID) tag of yet another embodiment of the present invention.

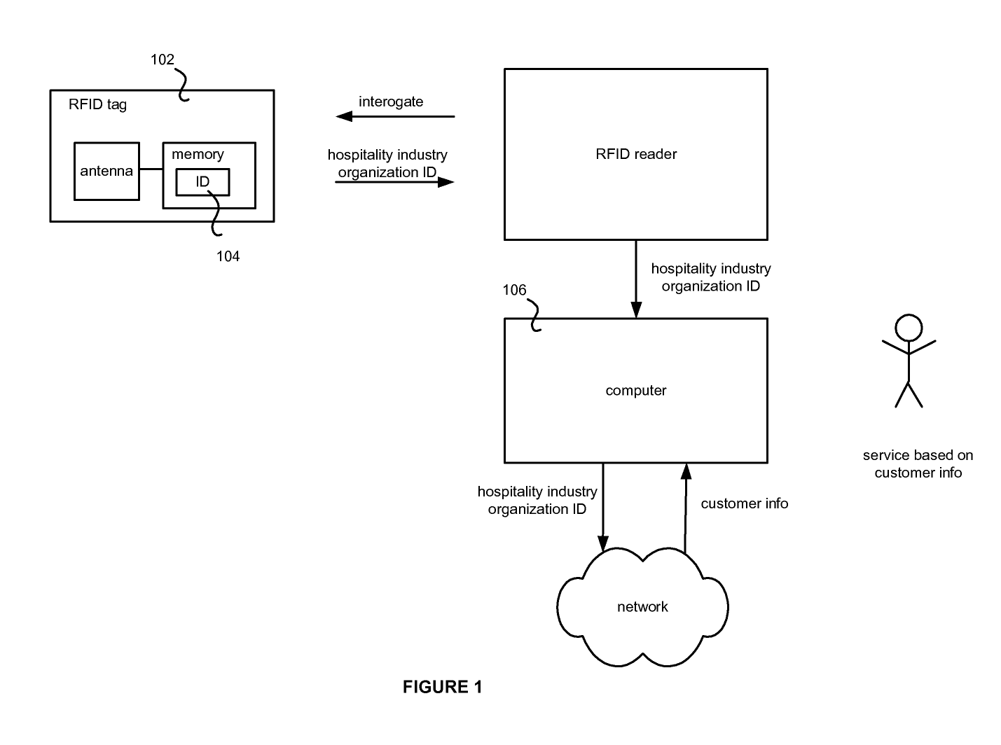

### DETAILED DESCRIPTION

One embodiment of the present invention includes using a Radio Frequency Identification (RFID) tag 102 to store a Hospitality Industry Organization ID 104 of a customer. The RFID tag 102 can be detected and the Hospitality Industry Organization ID 104 determined. A device 106 at a hospitality location can be used to determine information about the customer to facilitate service for the consumer.

The service for the customer can be a personalized greeting by a doorman; providing of food or drink; the retrieval of luggage or golf clubs or any other type of service.

The Hospitality Industry Organization ID can include IDs for hotel chains, golf clubs or other such organizations.

Multiple Hospitality Industry Organization IDs can be placed in a single RFID tag.

In one example, the RFID tag only provides a relevant ID at the hospitality location. For example, the RFID tag can contain multiple IDs and the RFID tag only responds to interrogation from a hospitality location with the ID relevant for that location.

A rental car company can put the Hospitality Industry Organization ID into the RFID tag when the customer rents the vehicle.

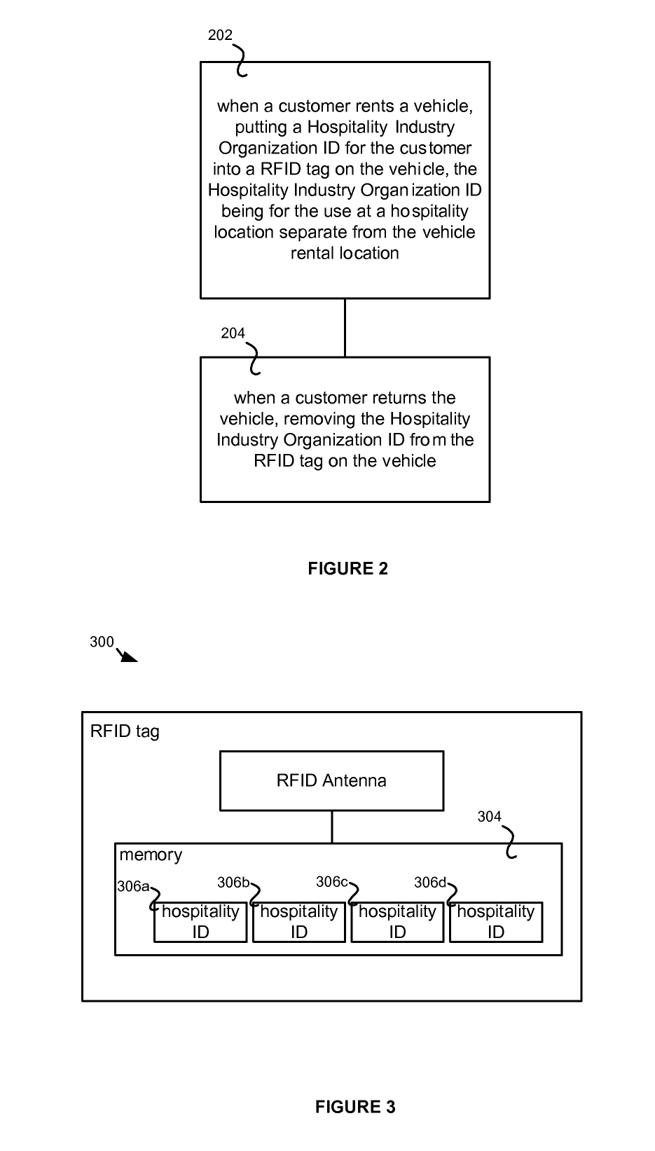

As shown in FIG. 2, one embodiment, when a customer rents a vehicle in step 202, a Hospitality Industry Organization ID for the customer is put into a RFID tag on the vehicle. The Hospitality Industry Organization ID can be for the use at a hospitality location separate from the vehicle rental location. When a customer returns the vehicle in step 204, the Hospitality Industry Organization ID can be removed from the RFID tag on the vehicle.

FIG. 3 shows an exemplary RFID tag 300 if one embodiment. The RFID tag 300 can comprise of an antenna 302 and a memory 304 storing multiple Hospitality Industry Organization IDs 306a, 306b, 306c and 306d.

In one embodiment, the RFID tag 300 is such that only the relevant Hospitality Industry Organization ID is provided at a hospitality location. A computer at a hospitality location can be used to determine information about the customer to facilitate service for the consumer.

The RFID tag can be attached to a vehicle. In one embodiment, a rental car company can put the Hospitality Industry Organization ID into the RFID tag, when a customer rents the vehicle. The rental car company can then remove the Hospitality Industry Organization ID from RFID tag when the rental vehicle is returned.

An RFID tag can be used to identify a guest coming on-site, into a hotel or other hospitality industry establishment e.g. restaurants, casinos, country clubs etc . . . The tag may be configured to allow the service system at the site to expedite the provision of services to the guest. The tag may be permanently assigned to a particular individual or may be attached to a vehicle and programmed with the data related to an individual on a temporary basis. Examples of use cases are given below. The use cases differ significantly from those disclosed in US Patent Publication No. 2005/0038741, filed Jul. 21, 2004, entitled “METHOD AND SYSTEM FOR A TRAVEL-RELATED MULTI-FUNCTION FOB”, by Bonalle, et al. (Assignee: American Express Corporation), in which the inventors disclose use of an RFID enabled device to store personal and payment information using secure applications, utilizing a file structure that allows for an encrypted data transfer between RFID reader and RFID device. The RFID device may be embedded in a key fob or plastic card, or similar format common to the payment industry. The particular data structure and protocols used in the above mentioned application are generally suitable only for short range proximity applications and thus are not generally suitable for use for guest identification in a vehicle or at a venue entrance.

Examples of embodiments of the present invention can include:
1) A Radio Frequency Identification (RFID) device with a personal identification number specific to an individual is mounted on a vehicle. Upon entering the premises of a hospitality establishment the tag can be read by a suitably located and configured RFID reader. The name and service information can be retrieved from a database hosted by the establishment or a partner organization which provides data to the establishment. The establishment can utilize the data to prepare for the guest arrival. Examples of suitable preparation may be: dispatch of a doorman to greet the guest, retrieving and pre-positioning of golf clubs and/or a golf cart, preparation of other services that are suitable for the situation on site. An example of this last application might be the preparation of cocktails for the guest should the guest arrive at a time that the establishment might normally anticipate the guest to desire these services.
2) A partner arrangement with a rental car facility which attaches a suitably configured Radio Frequency Identification (RFID) tag to its fleet of vehicles for hire. Upon renting a vehicle the tag can be programmed with the renter's identification number. The tag is read by suitably positioned and configured RFID readers at area hospitality establishments and services are provided on site in a similar fashion disclosed above. When the rental vehicle is returned, the personal identification number data stored in the memory of the RFID tag can be erased or changed such that tag is no longer recognized as being in position of the previous renter.
3) The Radio Frequency Identification (RFID) device may be carried by the guest, who places it on a vehicle or displays it to a suitably configured RFID reader upon approaching a hospitality establishment. Services are provided to the guest as discussed above.

In any of the above cases, the memory contained in the RFID chip may be sufficient such that a number of personal identification numbers are stored on a single device. The assignment of the personal identification numbers may be such that they identify both the establishment and the individual in a coded fashion that identifies the user only to those establishments to which he desires. Further this allows that participating merchants may be able to identify a customer but cannot easily identify other merchants frequented by the customer unless the customer has pre-approved the data sharing. For example a typical RFID tag may have 512 bits of user configurable memory. This is sufficient to store more than 10 user personal identification numbers. Each of which may used to encode more than 1 trillion unique combinations. Further with many commercial chip offerings it may be possible to password protect data fields such that the data is assigned memory locations cannot be retrieved by a reader that is not configured with the password.

The assignment of passwords and communication protocols may follow any of a number of schemes that give advantage in the particular use case deployed.

The foregoing description of preferred embodiments of the present invention has been provided for the purposes of illustration and description. It is not intended to be exhaustive or to limit the invention to the precise forms disclosed. Many embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the claims and their equivalents.

1. A method comprising:
using a Radio Frequency Identification (RFID) tag to store a Hospitality Industry Organization ID of a customer;
detecting the RFID tag and determining the Hospitality Industry Organization ID;
using a device at a hospitality location to determine information about the customer to facilitate service for the consumer.

2. The method of claim 1, wherein the service for the customer is a personalized greeting by a doorman.

3. The method of claim 1, wherein the service is the providing of food or drink.

4. The method of claim 1, wherein the service is the retrieval of luggage or golf clubs.

5. The method of claim 1, wherein multiple Hospitality Industry Organization IDs are placed on the RFID tag.

6. The method of claim 5, wherein the RFID tag only provides a relevant ID at the hospitality location.

7. The method of claim 1, wherein the RFID tag is attached to a vehicle.

8. The method of claim 7, wherein a rental car company puts the Hospitality Industry Organization ID into the RFID tag when the customer rents the vehicle.

9. The method of claim 8, wherein the rental car company removes the Hospitality Industry Organization ID from RFID tag when the rental vehicle is returned.

10. A method comprising:
when a customer rents a vehicle, putting a Hospitality Industry Organization ID for the customer into a Radio Frequency Identification (RFID) tag on the vehicle, the Hospitality Industry Organization ID being for the use at a hospitality location separate from the vehicle rental location; and
when a customer returns the vehicle, removing the Hospitality Industry Organization ID from the RFID tag on the vehicle.

11. The method of claim 10, wherein multiple Hospitality Industry Organization IDs are placed on the RFID tag.

12. The method of claim 11, wherein the RFID tag only provides a relevant ID at the hospitality location.

13. The method of claim 10, further comprising:
detecting the RFID tag and determining the Hospitality Industry Organization ID.

14. The method of claim 13, further comprising:
using a computer at a hospitality location to determine information about the customer to facilitate service for the consumer.

15. A Radio Frequency Identification (RFID) tag comprising:
an antenna; and
a memory storing multiple Hospitality Industry Organization IDs

16. The RFID tag of claim 15, wherein only the relevant Hospitality Industry Organization ID is provided at a hospitality location.

17. The RFID tag of claim 15, wherein a computer at a hospitality location is used to determine information about the customer to facilitate service for the consumer.

18. The RFID tag of claim 15, wherein the RFID tag is attached to a vehicle.

19. The RFID tag of claim 16, wherein a rental car company puts the Hospitality Industry Organization ID into the RFID tag when a customer rents the vehicle.

20. The RFID tag of claim 19, wherein the rental car company removes the Hospitality Industry Organization ID from RFID tag when the rental vehicle is returned.
